(19) United States
(12) Patent Application Publication
(10) Pub. No.: US 2018/0093695 A1
(43) Pub. Date: Apr. 5, 2018

(54) DEVICE FOR DETECTING APPROACH DISTANCE OF LIVING BODY

(71) Applicant: MAZDA MOTOR CORPORATION, Hiroshima (JP)

(72) Inventors: Reiji HATTORI, Fukuoka-shi (JP); Yuhei MORIMOTO, Amagasaki-shi (JP); Yutarou ONO, Fukuoka-shi (JP); Masayuki WATANABE, Hiroshima (JP); Nanae MICHIDA, Hiroshima (JP); Atsuhide KISHI, Hiroshima (JP); Kazuo NISHIKAWA, Hiroshima (JP)

(73) Assignee: MAZDA MOTOR CORPORATION, Hiroshima (JP)

(21) Appl. No.: 15/717,504

(22) Filed: Sep. 27, 2017

(30) Foreign Application Priority Data
Sep. 30, 2016 (JP) 2016-192587

(51) Int. Cl. B62D 1/04; G01B 7/14

(52) U.S. Cl. CPC B62D 1/046; B60Y 2400/301; G01B 7/14

(57) ABSTRACT

A device for detecting an approach distance of a living body is provided. The device detects hover touch. The surfaces of a first electrode and a second electrode are covered by an insulator to form an electrode section. A high-frequency power source is connected to the first electrode via an inductive element for forming a resonance circuit. An ammeter is connected to the second electrode. A correlation between a resonance frequency and a resonance resistance is obtained. It is determined that the living body is in hover touch with the electrode section when the resonance resistance is higher than an initial resistance corresponding to a leakage resistance between the first and second electrodes, and the resonance resistance increases or decreases whereas the resonance frequency decreases or increases, based on the correlation.

### CROSS-REFERENCE TO RELATED APPLICATION

This application claims priority to Japanese Patent Application No. 2016-192587 filed on Sep. 30, 2016, the entire disclosure of which is incorporated by reference herein.

### BACKGROUND

The present disclosure relates to a device for detecting an approach distance of a living body.

Recently, various types of sensors detecting a relation between the sensors and a living body have been developed. Japanese Unexamined Patent Publication No. 2014-210127 discloses a device for sensing a heart rate of a living body based on a change in the distance between capacitance sensors. Japanese Unexamined Patent Publication No. 2014-44225 discloses a device for sensing presence or absence of operation touch based on a change in a capacitance. Japanese Unexamined Patent Publication No. 2016-220961 discloses a resonance circuit, in which an electrode section has the maximum capacitance and the resistance at the resonance point is the skin resistance of a living body.

Recently, when a living body is away from an object, detecting that the living body is within a predetermined short distance from the object (within a “hover touch” range) has been desired. For example, in actual autonomous driving of a vehicle, detecting whether or not the hands and fingers of the driver are close to a steering handle and ready for steering in an emergency is desired.

The present disclosure was made in view of these circumstances. The present disclosure provides a device for detecting an approach distance of a living body. The device detects that the living body is within a hover touch range.

### SUMMARY

The present disclosure proposes the following solution. According to a first aspect,

a device for detecting an approach distance of a living body including:

an electrode section including a first electrode and a second electrode, surfaces of the first and second electrodes being covered by an insulator;

a high-frequency power source connected to the first electrode via an inductive element for forming a resonance circuit;

an ammeter connected to the second electrode; and

a controller controlling the high-frequency power source and receiving a current detected by the ammeter.

The controller executes
a step (a) of obtaining a correlation between a resonance frequency and a resonance resistance, the resonance frequency and the resonance resistance being obtained when the ammeter detects a state of a current indicating a resonance in sweeping a frequency of the high-frequency power source, and
a step (b) of determining that the living body is in hover touch with the electrode section when the resonance resistance is higher than an initial resistance corresponding to a leakage resistance between the first and second electrodes, and the resonance resistance increases or decreases whereas the resonance frequency decreases or increases, based on the correlation obtained in the step (a).

According to the solution, whether or not the living body is in hover touch can be determined based on the correlation between the resonance resistance and the resonance frequency, which is obtained from a simple configuration.

In some preferred embodiments,

the controller determines, in the step (b), a distance between the living body and the electrode section based on an increase in the resonance resistance from the initial resistance. In this case, the distance between the electrode section and the living body can be obtained.

The controller determines, in the step (b), whether or not a distance between the living body and the electrode section falls within a predetermined distance range by comparing a predetermined threshold to an increase in the resonance resistance from the initial resistance. In this case, the distance between the electrode section and the living body can be obtained in hover touch.

The first and second electrodes are stacked one above the other. This configuration is more advantageous than the configuration where the two electrodes are arranged in parallel to prevent an increase in the resistance.

The first and second electrodes are arranged in parallel. This configuration is advantageous in detecting a wide range of information on the living body such as the contact area of the living body with the electrodes and whether or not the living body sweats.

The electrode section is provided in an operation section of a moving object. This configuration detects hover touch with the operation section.

The operation section is a steering handle of a vehicle. This configuration detects hover touch with the steering handle.

The electrode section includes a pair of electrode sections located at right and left ends of the steering handle in a neutral position. This configuration is advantageous in reliably detecting the state of hover touch with the steering handle using a minimum number of the electrode sections.

An operation system of the moving object is controlled in accordance with a change in the increase in the resonance resistance from the initial resistance. This configuration controls an operation system utilizing the state of hover touch.

The present disclosure detects hover touch.

### BRIEF DESCRIPTION OF THE DRAWINGS

FIG. 1 illustrates that a fingertip touches an electrode section in which a resonance circuit is embedded.

FIG. 2 is a characteristic graph illustrating a correlation between a resonance resistance and a resonance frequency.

FIG. 3 illustrates an example where a pair of electrode sections are provided for a steering handle.

FIG. 4 illustrates an exemplary control system according to the present disclosure.

FIG. 5 illustrates exemplary control using the controller of FIG. 4.

FIG. 6 corresponds to FIG. 1 and illustrates that two electrodes are stacked one above the other.

FIG. 7 is a flow chart illustrating exemplary control of in-vehicle devices corresponding to the state of hover touch.

### DETAILED DESCRIPTION

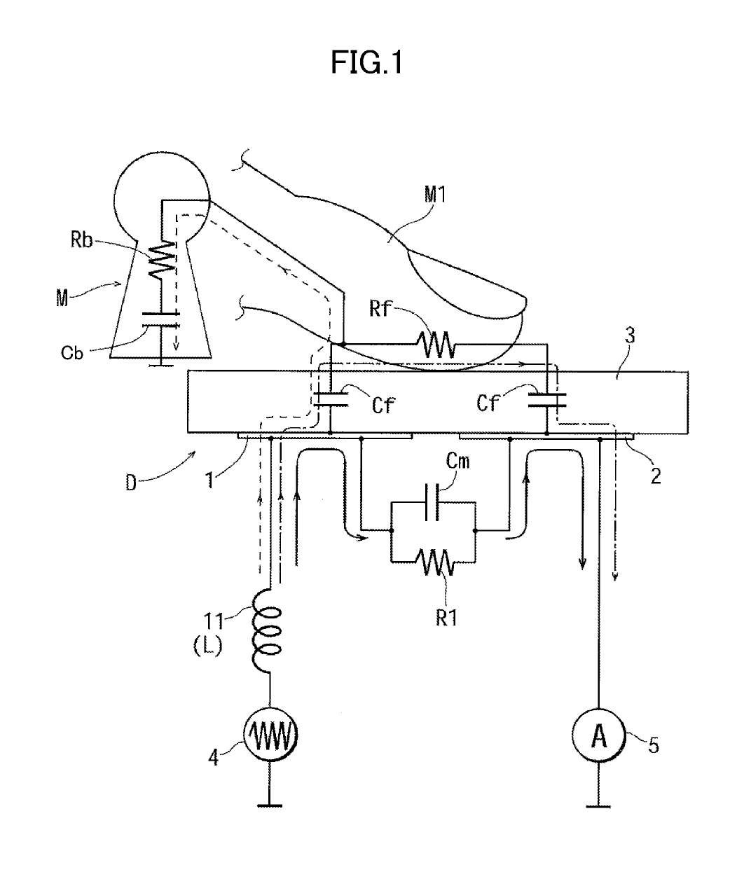

In FIG. 1, reference numeral 1 denotes a first electrode (e.g., a sender electrode), and 2 denotes a second electrode (e.g., a receiver electrode). The electrodes 1 and 2 are arranged in parallel in this embodiment. The surfaces of the electrodes 1 and 2 are covered by an insulator 3. The insulator 3 is provided across the electrodes 1 and 2. The insulator 3 is shown thick in FIG. 1 but is actually thin. The electrodes 1 and 2 and the insulator 3 form an electrode section D.

The first electrode 1 is connected to a high-frequency power source 4. The high-frequency power source 4 has a variable (sweepable) frequency within a range, for example, from 500 KHz to 4 MHz. An ammeter 5 as a means for measuring a current is connected to the second electrode 2. In order to form a resonance circuit for the electrode section D, an inductive element 11 with an inductance L is interposed between the first electrode 1 and the high-frequency power source 4.

In FIG. 1, reference character M denotes a human body (a driver of a vehicle in this embodiment) as a living body, and M1 denotes the fingertip of the human. FIG. 1 illustrates an equivalent circuit when the fingertip M1 touches the electrode section D (the insulator 3 thereof). Specifically, R1 denotes a leakage resistance between the electrodes 1 and 2, and Cm denotes a mutual capacitance between the electrodes 1 and 2. Reference character Cf denotes a capacitance between the fingertip M1 and the electrode 1 or 2 (the capacitances between the fingertip M1 and the first and second electrodes 1 and 2 are indicated by the same value Cf). Reference character Rf denotes a skin resistance. The skin resistance is variable depending on a contact area.

When the fingertip M1 touches the electrode section D, a human body ground path through the body of the driver as the living body M is formed. That is, the living body M as the driver of the vehicle is seated on the driver's seat, thereby being grounded to the vehicle body. In the human body ground path, Rb denotes a human body resistance, and Cb denotes a human body capacitance.

When the fingertip M1 is far away from the insulator 3 (e.g., by 30 cm or more), the skin resistance Rf and the human body grounding are ignored. Thus, a current coming from the high-frequency power source 4 flows through the inductive element 11, the first electrode 1, the leakage resistor R1, and the mutual capacitor Cm to the second electrode 2. Such a current flow is indicated by the solid line in FIG. 1.

When the fingertip M1 touches the insulator 3, two circuit systems are generated by the living body M. The first circuit system generated by the living body M is related to the skin resistance Rf. A current coming from the high-frequency power source 4 flows through the inductive element 11, the first electrode 1, the left capacitor Cf in FIG. 1, the skin resistor Rf, and the right capacitor Cf in FIG. 1 to the second electrode 2. Such a current flow is indicated by the one-dot-chain line in FIG. 1.

The second circuit system generated by the living body M is the human body ground path. A current coming from the high-frequency power source 4 flows through the inductive element 11, the first electrode 1, the left capacitor Cf in FIG. 1, the human body resistor Rb, and the human body capacitor Cb. Such a current flow is indicated by the broken line. The current does not flow through the ammeter 5.

Even when the fingertip M1 is a little away from the insulator 3 (i.e., the fingertip M1 does not touch the insulator 3 but within a hover touch range, which is at a short distance), the capacitance Cf is generated. Thus, the current flows not only through the path indicated by the solid line, but also through the path indicated by the broken line. That is, when the fingertip M1 is first far away from the electrode section D (the insulator 3 thereof), then gradually comes closer to the electrode section D, and eventually touches the electrode section D, the path of the current sequentially changes from the state indicated by the solid line in FIG. 1, the states indicated by the solid and broken lines in FIG. 1, and the states indicated by the solid, broken, and one-dot-chain lines in FIG. 1.

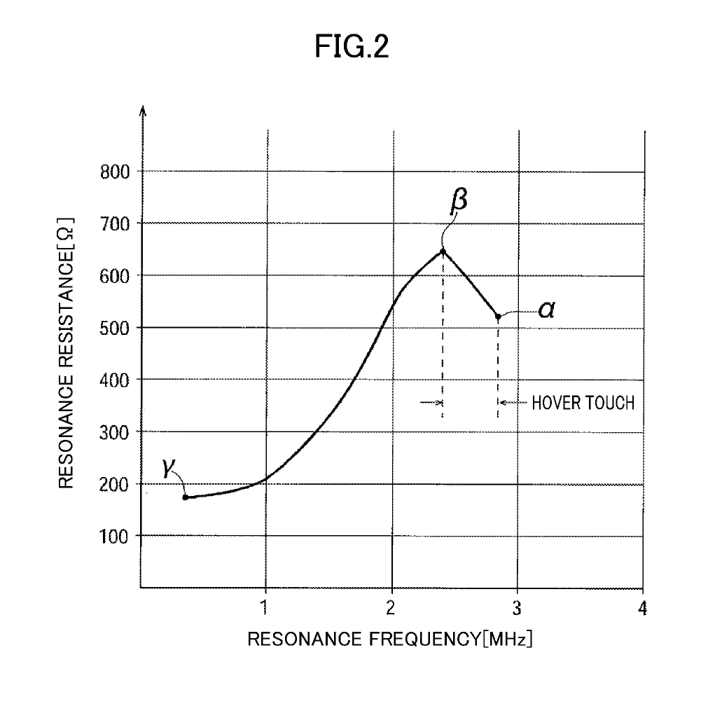

Assume that the fingertip M1 is first far away from the insulator 3, then gradually comes closer to the insulator 3, and eventually strongly presses the insulator 3. While the position of the fingertip M1 changes in this manner, the frequency at the high-frequency power source 4 is changed (swept). The correlation between a resonance frequency and a resonance resistance, the resonance frequency and the resonance resistance being obtained at these times is collectively shown in FIG. 2. The resonance is detected when the ammeter 5 detects an extreme value. The frequency at this resonance is the resonance frequency and the resistance at this resonance is the resonance resistance. The resonance resistance is calculated based on the voltage generated at the high-frequency power source 4 and the current detected by the ammeter 5.

In FIG. 2, when the fingertip M1 is far away from the insulator 3, the initial resistance at the resonance is the leakage resistance R1, and the resonance frequency at this time is an initial resonance frequency. The time point of the initial resistance (i.e., R1) is indicated by reference character a in FIG. 2.

When the fingertip M1 comes closer to the insulator 3 after the initial resistance R1 has been detected, the current flows as indicated by the broken line in FIG. 1. The current detected by the ammeter 5 decreases and the resonance resistance increases, while the resonance frequency decreases. In this manner, while the resonance resistance increases from the initial resistance, and the resonance frequency decreases from the initial frequency, the fingertip M1 is in hover touch, that is, close to the insulator 3.

When the fingertip M1 touches the insulator 3, the current also flows through the path indicated by the one-dot-chain line in FIG. 1, and the resonance resistance changes from the increasing state to a decreasing state. While the fingertip M1 strongly presses the insulator 3 (i.e., with an increase in the contact area of the fingertip M1 with the insulator 3), the skin resistance Rf decreases. Thus, the resonance resistance changes to the decreasing state. With the decrease in the resonance resistance, the resonance frequency decreases. When the resonance resistance reaches the extreme value (the maximum value), at which the resonance resistance changes from the increasing state to the decreasing state, the hover touch ends. The end of the hover touch is indicated by reference character β in FIG. 2. The maximum distance (i.e., the distance between the electrode section D and the fingertip M1) at which the hover touch can be detected may be 6 cm or longer.

As described above, when the resonance resistance is higher than an initial resistance (within the range from α to β in FIG. 2), and the resonance resistance increases or decreases whereas the resonance frequency decreases or increases, it can be determined that the living body is in hover touch with the electrode section.

In the final state where the fingertip M1 strongly presses the electrode section D, the resonance resistance reaches the minimum value, which is indicated by reference character γ in FIG. 2. The minimum resonance resistance can be determined as the skin resistance. When the skin resistance (i.e., the minimum resonance resistance) starts decreasing, that is, becomes lower than or equal to a predetermined value, although the resonance frequency hardly changes, it can be determined that the living body M sweats.

Based on the resonance resistance within the range from β to γ, the posture of the living body M can be determined. A change in the posture can be detected from a change in the resonance resistance. Specifically, depending on, for example, how the living body M is seated on the driver's seat (e.g., when the living body M leans on the seat back, when the back of the living body M is away from the seat back, and when the buttocks of the living body M are away from the driver's seat), the position of grounding the living body M to the vehicle body differs, which leads to a change in the resonance resistance. If the correlation between the posture of the living body M and the resonance resistance is prepared in advance as a database, the posture of the living body M can be determined by collating the obtained resonance resistance with the database.

In FIG. 2, within the range from β to γ, the contact area of the fingertip M1 with the insulator 3 increases. Thus, based on the capacitance calculated from the resonance frequency within this range, the contact area of the fingertip M1 with the insulator 3 can be obtained.

In the case where a current flows as indicated by the one-dot-chain line in FIG. 1, the circuit resistance Z at the resonance is calculated from the following equation (1). In the equation, f is a resonance frequency, which is known from the output from the high-frequency power source 4. At the resonance, since L and Cf cancel each other, the circuit resistance Z is equal to the skin resistance Rf.

$$Z = {R}_{f} + j2 π fL + \frac{2}{j2 π {fC}_{f}} \qquad ( 1 )$$

The capacitance value Cf is calculated from the following equation (2).

$$f = \frac{1}{2 π \sqrt{{LC}_{f}}} \qquad ( 2 )$$

Since the resonance frequency f and the inductance L of the inductive element 11 are known, the capacitance Cf can be calculated from the equation (2). From the obtained capacitance Cf, the contact area of the fingertip M1 can be obtained. For example, the relation between the capacitance Cf and the contact area is stored as a database, and the obtained Cf is collated with the database to determine the contact area.

When a current flows as indicated by the solid line and the broken line in FIG. 1, the circuit resistance and the capacitance can be calculated as in the equations (1) and (2). In this case, where a current flows as indicated by the solid line, Rf may be replaced with R1, and Cf may be replaced with Cm. In the case where a current flows as indicated by the broken line in FIG. 1, Rf may be replaced with Rb, and Cf may be replaced with Cf+Cb.

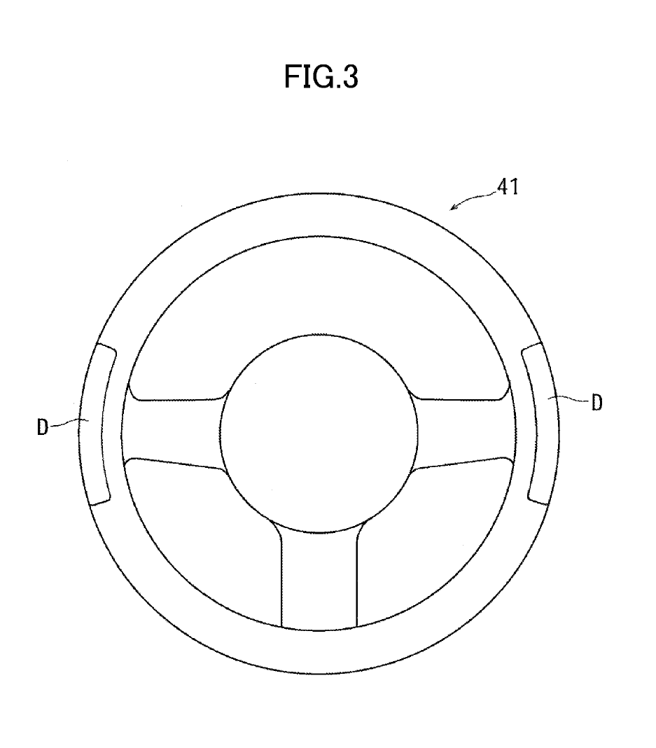

FIG. 3 illustrates that a pair of electrode sections D are provided in the steering handle 41. Specifically, FIG. 3 shows that the steering handle 41 is in a neutral position, and that the electrode sections D are provided on right and left ends of the steering handle 41.

In the example of FIG. 3, the first and second electrodes 1 and 2 forming the electrode section D are stacked one above the other in the vertical direction. The stacking structure is more advantageous than a parallel structure, which requires a reduction in the width of the second electrode 2 and raises a concern of an increasing resistance. The smaller the value obtained by dividing the area of the first electrode 1 by the area of the second electrode 2, the more the sensitivity of the sensor improves (i.e., the resonance resistance changes with an increase in the resonance frequency). Thus, the second electrode 2 has a larger area than the first electrode 1 in one preferred embodiment. In this embodiment, the first electrode 1 is located above the second electrode 2 (i.e., the first electrode 1 is closer to the surface of the steering handle 41). Only the single high-frequency power source 4 and the single ammeter 5 are provided for the electrode sections D. A switching element is used to select the electrode section D to be connected to the high-frequency power source 4 and the ammeter 5.

In the embodiment of FIG. 3, the steering handle 41 is used for, for example, a vehicle which performs autonomous driving. Whether or not the hands and fingers of the driver as the living body M are located close to the steering handle 41 is detected. Providing the pair of right and left electrode sections D is advantageous in reliably detecting the driving state of (particularly, the state of hover touch) the steering handle 41 using such a small number of the electrode sections D.

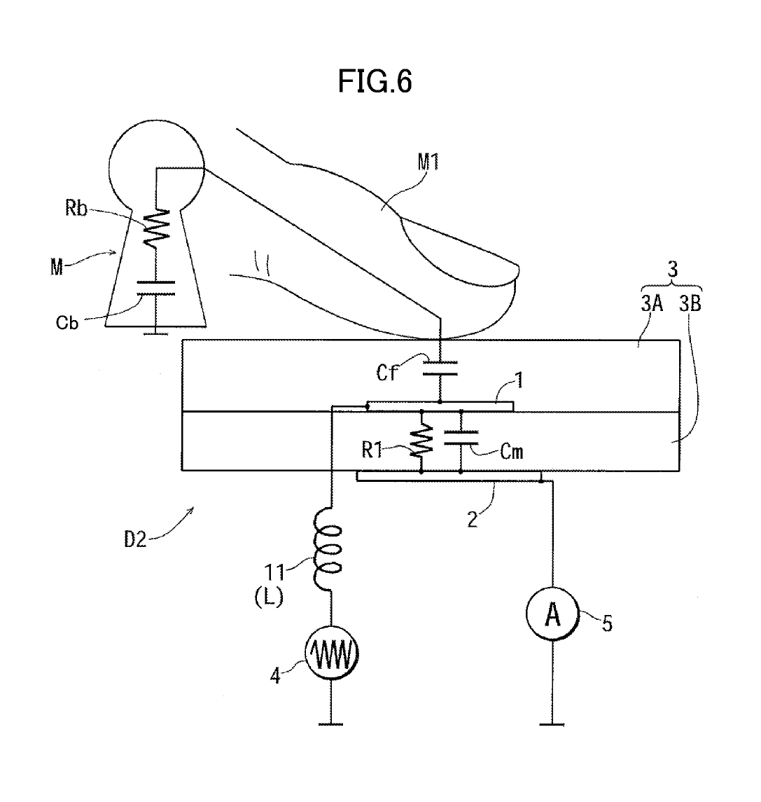

FIG. 6 illustrates an example where two electrodes 1 and 2 are stacked one above the other. The same reference characters as those shown in FIG. 1 are used to represent equivalent elements, and repetitive explanation will be omitted. In FIG. 6, the second electrode 2 is provided below the first electrode 1 with a space. The insulator 3 includes a first insulator 3A covering the top of the first electrode 1, and a second insulator 3B insulating the electrode 1 from the electrode 2. The insulators 3A and 3B are made of the same material. In the equivalent circuit shown in FIG. 6, the skin resistance Rf is not present. However, the equivalent circuit of FIG. 6 also has the characteristics shown in FIG. 2.

In FIG. 6, the capacitance Cf occurs between the first electrode 1 and the fingertip M1. Actually, it also occurs between the second electrode 2 and the fingertip M1. At this time, the capacitance between the first electrode 1 and the fingertip M1 is referred to as Cf1, and the capacitance between the second electrode 2 and the fingertip M1 is referred to as Cf2. The relation between the two capacitances Cf1 and Cf2 is defined by the following equation (3). In the equation, RR is a constant.

Cf2=RR·Cf1 (3)

When the constant RR changes within the range, for example, from 0.1 to 10 (e.g., by using the electrodes 1 and 2 with different widths), the smaller RR, the wider the range between α and β in FIG. 2. Then, the resonance resistance increases more with a decrease in the resonance frequency, which is advantageous in stably detecting hover touch (improving the robustness). On the contrary, the greater RR, the narrower the range between α and β. Then, the resonance resistance increases less with a decrease in the resonance frequency. In order to obtain the characteristics shown in FIG. 2, RR may fall within a range from about 0.1 to about 1.0. This is also applicable to the case where the two electrodes 1 and 2 are arranged in parallel as shown in FIG. 1. In the stacking structure, the relation between the widths of the two electrodes 1 and 2 is as follows. The second electrode 2 is wider than the first electrode 1. The greater RR, the longer the portions of the second electrode 2 exposed from the width ends of the first electrode 1 on the right and left.

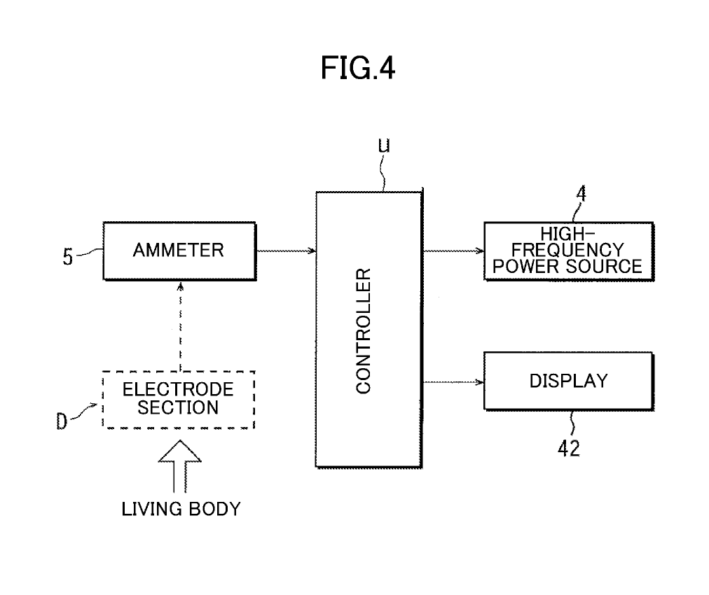

FIG. 4 illustrates an exemplary control system according to the present disclosure. In FIG. 4, reference character U denotes a controller (control unit) formed by utilizing a microcomputer. The controller U receives the current detected by the ammeter 5. The controller U controls the high-frequency power source 4 and a display 42. The display 42 displays an alert, for example, when the hands of the driver (i.e., the living body M) are far away from the steering handle 41 for a long time in autonomous driving.

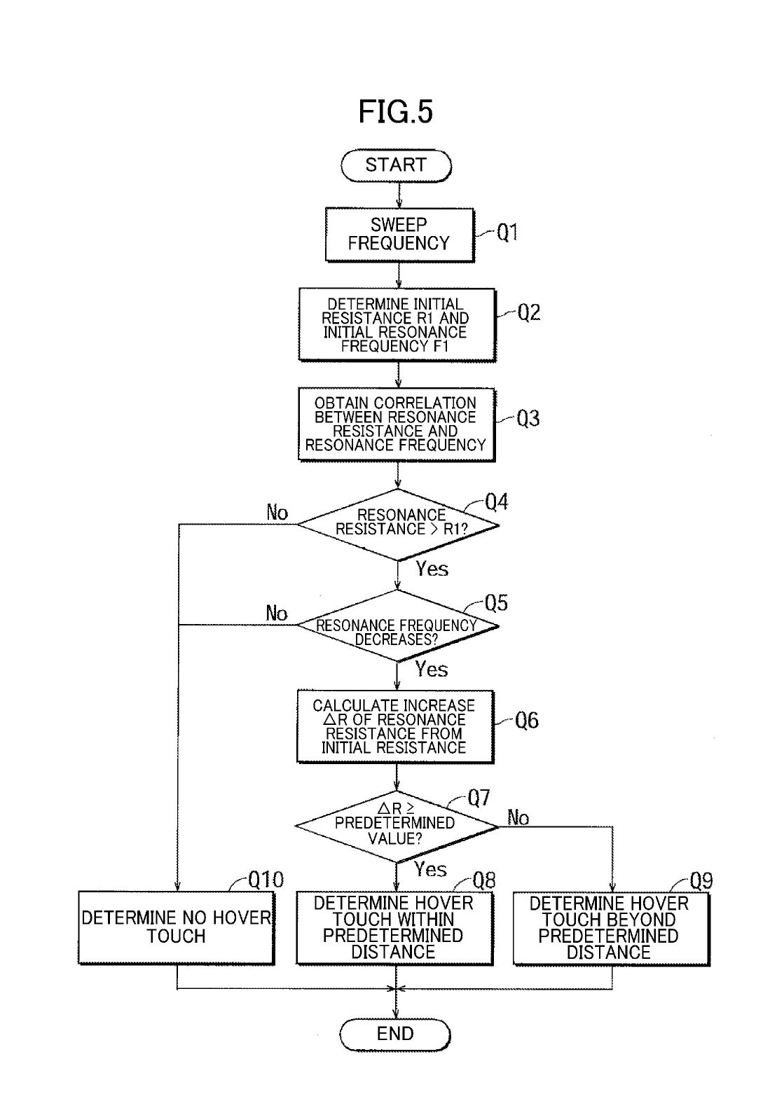

Exemplary control, particularly, detection of hover touch using the controller U will now be described with reference to the flow chart of FIG. 5. In the following explanation, reference character Q denotes a step. First, in Q1, the high-frequency power source 4 is controlled to change (sweep) the frequency within a certain frequency range.

After Q1, in Q2, the initial resistance (i.e., R1) and the resonance frequency fl at this time are determined. Then, in Q3, the correlation between the resonance resistance and the resonance frequency is obtained. Although the characteristics shown in FIG. 2 are obtained, the characteristics within the entire frequency range from α to γ are not always obtained.

After Q3, in Q4, presence or absence of a range in which the resonance resistance is higher than the initial resistance R1 is determined. If the question in Q4 is answered with YES, whether or not the resonance frequency is lower than the resonance frequency fl at the initial resistance is determined in Q5.

If the question in Q5 is answered with YES, hover touch is determined. At this time, in Q6, the increase ΔR is obtained by subtracting the initial resistance R1 from the current resonance resistance. Then, in Q7, whether or not the increase ΔR is greater than or equal to a predetermined value (i.e., a threshold) is determined. If the question in Q7 is answered with YES, hover touch within a predetermined distance (for example, 1 cm) is determined in Q8. If the question in Q7 is answered with NO, hover touch beyond the predetermined distance is determined in Q9.

If the question in Q4 is answered with NO or the question in Q5 is answered with NO, no hover touch is determined in Q10. That is, it is determined that the fingertips M1 of the driver as the living body M are far away from the steering handle 41 or touch the steering handle 41.

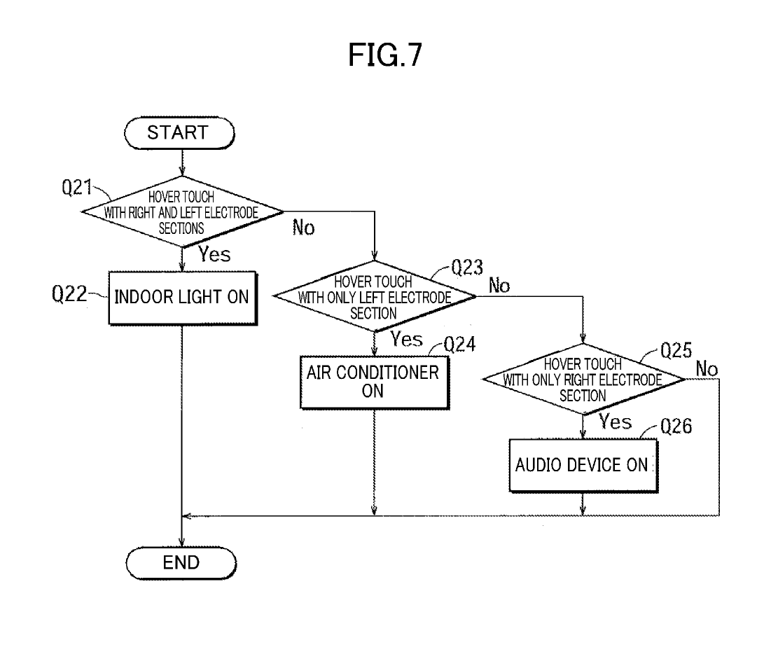

FIG. 7 is a flow chart illustrating exemplary control of in-vehicle devices corresponding to the state of hover touch with the pair of right and left electrode sections D shown in FIG. 3. The flow chart of FIG. 7 will now be described. First in Q21, whether or not the driver is in hover touch with each of the right and left electrode sections D is determined. If the question in Q21 is answered with YES, an indoor light is turned on in Q22.

If the question in Q21 is answered with NO, whether or not only the left electrode section D is in hover touch is determined in Q23. If the question in Q23 is answered with YES, an air conditioner is turned on (i.e., air conditioning is started) in Q24.

If the question in Q23 is answered with NO, whether or not only the right electrode section D is in hover touch is determined in Q25. If the question in Q25 is answered with YES, an audio device is turned on. If the question in Q25 is answered with NO, the procedure ends without controlling any in-vehicle device.

The embodiment has been described. The present disclosure is however, not limited to this embodiment. Any change can be made within the scope of the claims as appropriate. In addition to the state of hover touch, one or more of the posture (a change in the posture) of the driver, the contact area, and whether or not the living body sweats may be detected. The detection of hover touch is targeted not only at the fingertips, but also at the toes, elbows and any other parts of the living body. The moving object, to which the present disclosure is applicable, is not limited to the vehicle (particularly, automobile) but may also be a ship, an aircraft, and various types of objects which can be controlled by a human.

The electrode section D may be provided in various types of operation section, for example, the operation sections of devices mounted in a moving object such as a vehicle. For example, a fingertip may hit the electrode section D at a predetermined number of times (or may come closer and away from the electrode section D repeatedly without directly touching the electrode section D). With this movement used as a trigger, an instruction signal may be sent to a predetermined device (e.g., turn-on and turn-off of an air conditioner or an audio device). With detection of hover touch used as a trigger, an instruction signal may be sent to the predetermined device (i.e., a non-contact sensor may be provided). In accordance with the increase ΔR of the resonance resistance from the initial resistance, the distance between the electrode section D and the living body M may be determined continuously or at three or more steps. The steps or groups of steps shown in the flow chart indicate the functions of the controller U. A character indicating means may be added to the names of the functions to identify the elements included in the controller U. Obviously, the objective of the present disclosure is not limited to what is disclosed herein and may implicitly include essentially preferable or advantageous matters.

The present disclosure detects the state of hover touch using a simple configuration.

What is claimed is:

1. A device for detecting an approach distance of a living body comprising:
an electrode section including a first electrode and a second electrode, surfaces of the first and second electrodes being covered by an insulator;
a high-frequency power source connected to the first electrode via an inductive element for forming a resonance circuit;
an ammeter connected to the second electrode; and
a controller controlling the high-frequency power source and receiving a current detected by the ammeter, wherein
the controller executes
a step (a) of obtaining a correlation between a resonance frequency and a resonance resistance, the resonance frequency and the resonance resistance being obtained when the ammeter detects a state of a current indicating a resonance in sweeping a frequency of the high-frequency power source, and
a step (b) of determining that the living body is in hover touch with the electrode section when the resonance resistance is higher than an initial resistance corresponding to a leakage resistance between the first and second electrodes, and the resonance resistance increases or decreases whereas the resonance frequency decreases or increases, based on the correlation obtained in the step (a).

2. The device of claim 1, wherein
the controller determines, in the step (b), a distance between the living body and the electrode section based on an increase in the resonance resistance from the initial resistance.

3. The device of claim 1, wherein
the controller determines, in the step (b), whether or not a distance between the living body and the electrode section falls within a predetermined distance range by comparing a predetermined threshold to an increase in the resonance resistance from the initial resistance.

4. The device of claim 1, wherein
the first and second electrodes are stacked one above the other.

5. The device of claim 2, wherein
the first and second electrodes are stacked one above the other.

6. The device of claim 3, wherein
the first and second electrodes are stacked one above the other.

7. The device of claim 1, wherein
the first and second electrodes are arranged in parallel.

8. The device of claim 2, wherein
the first and second electrodes are arranged in parallel.

9. The device of claim 3, wherein
the first and second electrodes are arranged in parallel.

10. The device of claim 1, wherein
the electrode section is provided in an operation section of a moving object.

11. The device of claim 10, wherein
the operation section is a steering handle of a vehicle.

12. The device of claim 10, wherein
the electrode section includes a pair of electrode sections located at right and left ends of a steering handle in a neutral position.

13. The device of claim 10, wherein
an operation system of the moving object is controlled in accordance with a change in an increase in the resonance resistance from the initial resistance.
